(19) United States
(12) Patent Application Publication
(10) Pub. No.: US 2012/0169147 A1
(43) Pub. Date: Jul. 5, 2012

(54) Electromagnetic Propulsion Engine

(76) Inventors: Bashar Sadik Kirma, West Bloomfield, MI (US); Riyadh Lewis Kenaya, West Bloomfield, MI (US)

(21) Appl. No.: 13/337,265

(22) Filed: Dec. 26, 2011

Related U.S. Application Data
(60) Provisional application No. 61/460,438, filed on Jan. 3, 2011.

(51) Int. Cl. H02K 7/075

(52) U.S. Cl. 310/20

(57) ABSTRACT

An electromagnetic propulsion engine having at least one cylinder, at least one piston, a crankcase, at least one connecting rod secured to the piston and pivotally to a crankshaft enclosed within the crankcase, comprises a first magnetic body secured to a first end of the cylinder; a second magnetic body secured to the cylinder; a third magnetic body secured to a first end of the piston; a fourth magnetic body secured to a second end of the piston; wherein at least one of the first, second, third, and fourth magnetic bodies comprises an electromagnet; and a control module that selectively transmits current to the electromagnet to force the piston to move within the cylinder between the first magnetic body and the second magnetic body, and thereby, rotating the crankshaft.

### CROSS-REFERENCE TO RELATED APPLICATIONS

This application claims the benefit of U.S. Provisional Application No. 61/460,438, filed on Jan. 3, 2011. The disclosure of the above is incorporated herein by reference.

### FIELD

The present disclosure relates to engines and more particularly to an engine in which the motive force is electromagnetism.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Referring now to FIG. 1, a structural schematic drawing of a cross section through a piston, cylinder, crankshaft, and magnetic bodies of an electromagnetic engine according to the prior art is shown. An electromagnetic engine 100 includes a cylinder 102, a piston 104, a connecting rod 106, pins 108 and 110, a crankshaft 112, a crankcase 114, a permanent magnet 116, a conductive core 118, coils 120, and a control module 122.

The permanent magnet 116 is secured to an end of the piston 104. One end of the connecting rod 106 is connected to a second end of the piston 104 via the pin 108. The second end of the connecting rod 106 is connected to the crankshaft 112 via pin 110.

The control module 122 transmits current through the coils 120. The coils 120 may be made of one or more wires that wrap around the conductive core 118. As current travels through the coils 120, an electromagnetic field is generated. The electromagnetic field may force the permanent magnet 116 away from the conductive core 118.

The piston 104 may have a starting position of top dead center (TDC) as shown in FIG. 1. The piston 104 is in the TDC position when it is closest to the conductive core 118. The control module 122 may transmit current through the coils 120 that will generate an electromagnetic field to repel the permanent magnet 116, forcing the piston 104 away from the conductive core 118. As the piston 104 is forced away from the conductive core 118, the crankshaft 112 is rotated.

The control module 122 may continue transmitting the current to force the piston 104 away from the conductive core 118 until the piston 104 reaches bottom dead center (BDC). The piston 104 is in the BDC position when it is farthest away from the conductive core 118. The control module 122 may discontinue transmitting the current through the coils 120 until the piston 104 returns to the TDC position.

### SUMMARY

An electromagnetic propulsion engine having at least one cylinder, at least one piston, a crankcase, at least one connecting rod secured to the piston and pivotally to a crankshaft enclosed within the crankcase, comprises a first magnetic body secured to a first end of the cylinder; a second magnetic body secured to the cylinder; a third magnetic body secured to a first end of the piston; a fourth magnetic body secured to a second end of the piston; wherein at least one of the first, second, third, and fourth magnetic bodies comprises an electromagnet. A control module selectively transmits current to the electromagnet to force the piston to move within the cylinder between the first magnetic body and the second magnetic body, and thereby, rotating the crankshaft.

In further features, the strength of the electromagnet is adjustable. In other features, the control module continuously transmits the current. In still other features, the control module suspends transmitting the current periodically. In still other features, the control module selectively adjusts the current. In further features, the control module adjusts the current continuously.

In other features, the control module adjusts the current periodically. In still other features, the control module adjusts the current by reversing the current. In other features, the control module reverses the current periodically.

An electromagnetic propulsion engine having at least one cylinder, at least one piston, a crankcase, at least one connecting rod secured to the piston and pivotally to a crankshaft enclosed within the crankcase, comprises a first magnetic body secured to a first end of the cylinder; a second magnetic body secured to a second end of the cylinder; wherein the piston comprises a third magnetic body; wherein at least one of the first, second, and third magnetic bodies comprises an electromagnet; and a control module that selectively transmits current to the electromagnet to force the piston to move within the cylinder between the first magnetic body and the second magnetic body, and thereby, rotating the crankshaft.

In further features, the strength of the electromagnet is adjustable. In other features, the control module continuously transmits the current. In still other features, the control module suspends transmitting the current periodically. In still other features, the control module selectively adjusts the current. In further features, the control module adjusts the current continuously.

In other features, the control module adjusts the current periodically. In still other features, the control module adjusts the current by reversing the current. In other features, the control module reverses the current periodically.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a structural schematic drawing of a cross section through a piston, cylinder, crankshaft, and magnetic bodies of an electromagnetic engine according to the prior art;

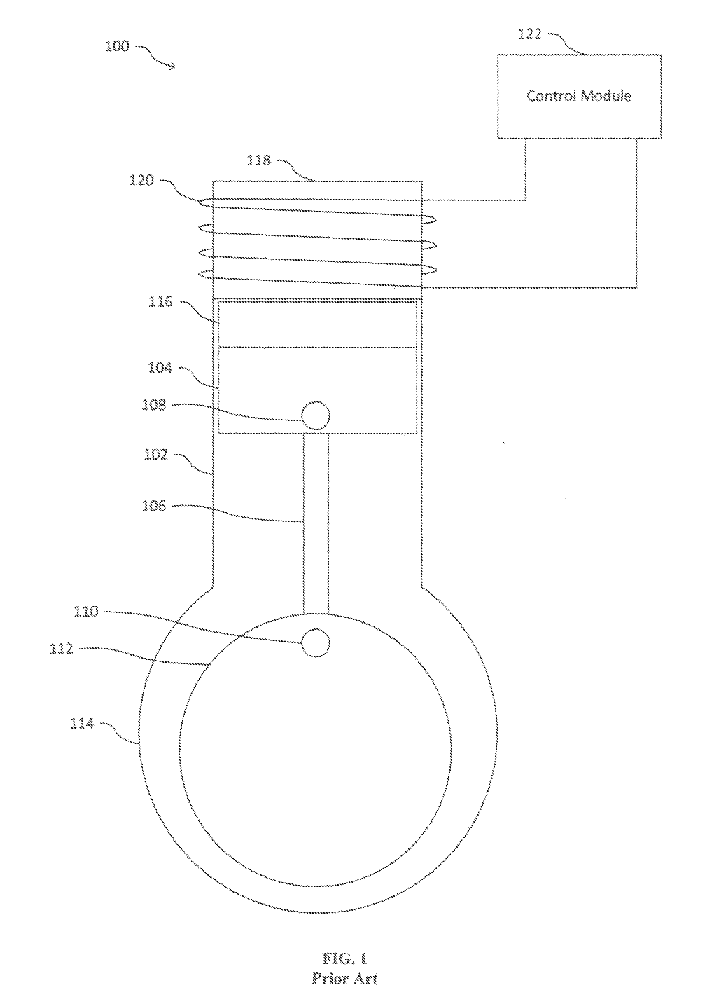

FIG. 2 is a structural schematic drawing of a cross section through a piston, cylinder, crankshaft, and magnetic bodies of an exemplary electromagnetic propulsion engine according to the principles of the present disclosure;

FIG. 3 is a structural schematic drawing of a cross section through a piston, cylinder, crankshaft, and magnetic bodies of a second exemplary electromagnetic propulsion engine according to the principles of the present disclosure;

FIG. 4 is a structural schematic drawing of a cross section through a piston, cylinder, crankshaft, and magnetic bodies of a third exemplary electromagnetic propulsion engine according to the principles of the present disclosure; and

FIG. 5 is a structural schematic drawing of a cross section through a piston, cylinder, crankshaft, and magnetic bodies of a fourth exemplary electromagnetic propulsion engine according to the principles of the present disclosure.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

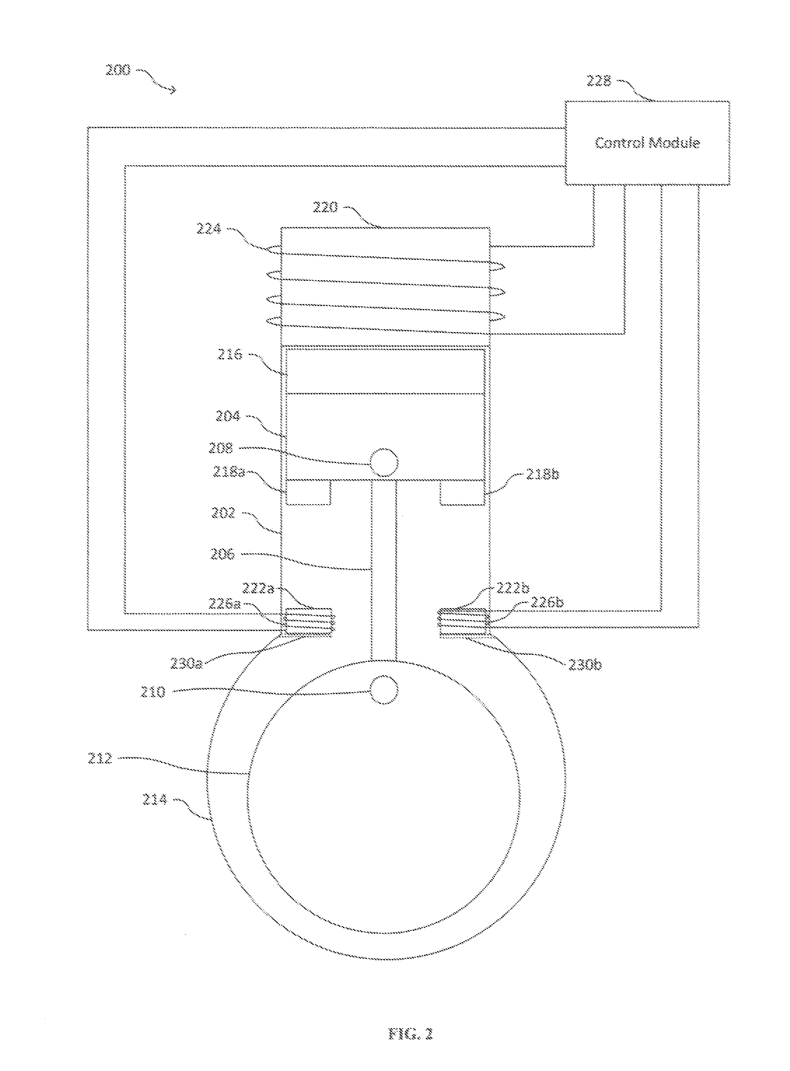

Referring now to FIG. 2, a structural schematic drawing of a cross section through a piston, cylinder, crankshaft, and magnetic bodies of an exemplary electromagnetic propulsion engine according to the principles of the present disclosure is shown. An electromagnetic propulsion engine 200 includes a cylinder 202, a piston 204, a connecting rod 206, pins 208 and 210, a crankshaft 212, a crankcase 214, permanent magnets 216, 218a, and 218b, conductive cores 220, 222a, and 222b, coils 224, 226a, and 226b, a control module 228, fixtures 230a and 230b, and a housing (not shown).

Only portions of the exemplary electromagnetic propulsion engines of the present disclosure are shown for simplicity. At least one cylinder 202 made of nonferromagnetic material is secured to the housing. The conductive core 220 may be secured to the housing or to the cylinder 202 to enclose an end of the cylinder 202. For simplicity reasons, only one cylinder 202 is shown. For example only, there may be more than one cylinder 202. Further, the cylinder 202 shown in FIG. 2 is in a vertical position. It is anticipated that the orientation of the system may be different such as in a horizontal position or at an angle.

The permanent magnets 216, 218a, and 218b are secured to the piston 204. For example, the permanent magnets 216, 218a, and 218b may be glued, bolted, welded, fastened, clamped, or secured to the piston 204 by any other means. In another implementation, the piston 204 may be made of a ferromagnetic material in the form of a permanent magnet instead of securing the permanent magnet 216 to the piston 204. The piston 204 is in the TDC position as shown in FIG. 2.

The conductive core 220 may be secured to a first end of the cylinder 202. The conductive cores 222a and 222b may be secured near a second end of the cylinder 202. In FIG. 2, the conductive cores 222a and 222b are secured to fixtures 230a and 230b respectively. The fixtures 230a and 230b may be attached to the walls of the cylinder 202. In various implementations, the conductive cores 230a and 230b may be secured to the walls of the cylinder 202 without the fixtures 230a and 230b.

When the piston 204 is at or near TDC, the control module 228 may transmit a current through the coils 224. The control module 228 may continue transmitting the current through the coils 224 until the piston 204 reaches BDC. In various implementations, the control module 228 may continue transmitting the current through the coils 224 for a predetermined period of time.

As the current travels through the coils 224, an electromagnetic field is generated. The electromagnetic field acts on the permanent magnet 216. The electromagnetic field repels the permanent magnet 216 and forces the piston 204 away from the conductive core 220. In various implementations, there may be a plurality of conductive cores, coils, and permanent magnets in place of conductive core 220, coils 224, and permanent magnet 216.

When the piston 204 is at or near TDC, the control module 228 may also transmit a current through the coils 226a and 226b. As the current travels through the coils 226a and 226b, second and third electromagnetic fields are generated. The second electromagnetic field acts on the permanent magnet 218a and the third electromagnetic field acts on the permanent magnet 218b. In various implementations, a single permanent magnet may be used in place of the permanent magnets 218a and 218b. Further, a single conductive core and coils may be used in place of conductive cores 222a and 222b and coils 226a and 226b.

The control module 228 may continue transmitting the current through the coils 226a and 226b until the piston 204 is at or near BDC. When the piston 204 is at or near BDC, the control module 228 may discontinue transmitting current through the coils 226a and 226b. In various implementations, the control module 228 may continue transmitting the current through the coils 226a and 226b for a predetermined period of time.

When the piston 204 is at or near BDC, the control module 228 may reverse the current transmitted through the coils 224. When the current transmitted through the coils 224 is reversed, the polarity of the electromagnetic field is also reversed. Accordingly, the permanent magnet 216 is forced toward the conductive core 220.

Also, when the piston 204 is at or near BDC, the control module 228 may reverse the current transmitted through the coils 226a and 226b. When the current transmitted through the coils 226a and 226b is reversed, the polarities of the second and third electromagnetic fields are reversed respectively. Accordingly, the permanent magnets 218a and 218b are forced away from the conductive cores 222a and 222b.

In various implementations, the control module 228 may selectively transmit the currents through the coils 224, 226a, and 226b. For example, the control module 228 may transmit current through the coils 224 to repel the permanent magnet 216, but never to attract it, and vice versa. Further, the control module 228 may transmit current through the coils 226a and 226b to attract the permanent magnets 218a and 218b, but never repel them, and vice versa.

The connecting rod 206 is connected to the piston 204 via pin 208. The connecting rod 206 is connected to the crankshaft 212 via pin 210. As the piston 204 moves within the cylinder 202, the crankshaft 212 is rotated within the crankcase 214.

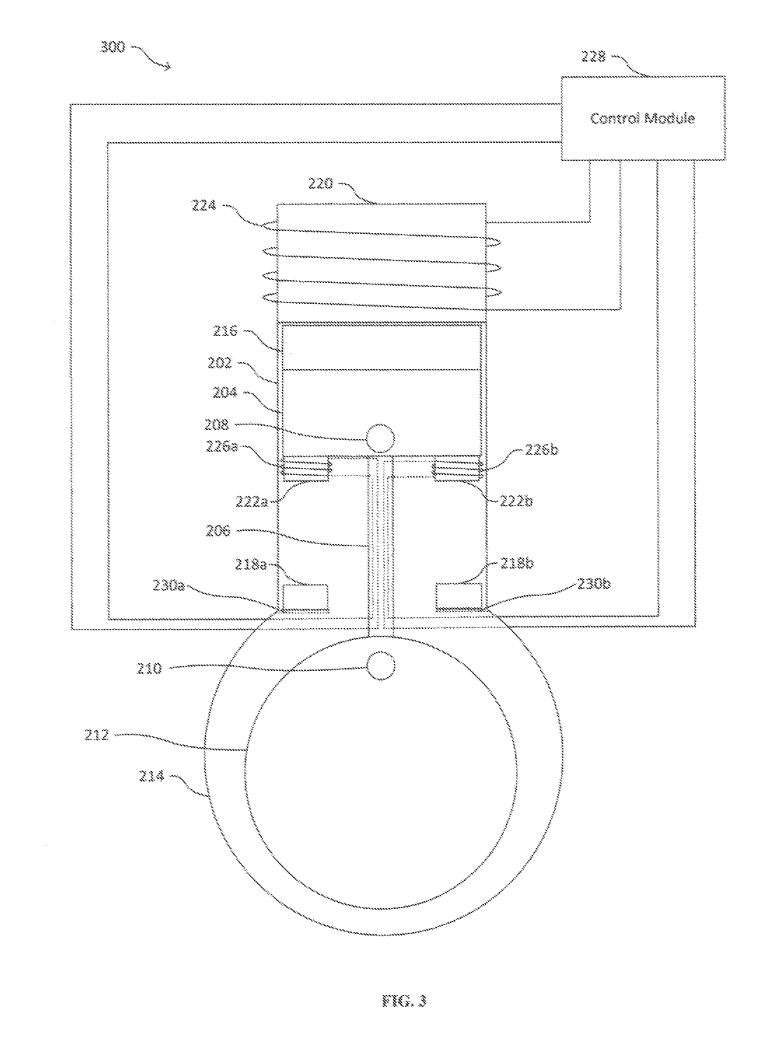

Referring now to FIG. 3, a structural schematic drawing of a cross section through a piston, cylinder, crankshaft, and magnetic bodies of a second exemplary electromagnetic propulsion engine according to the principles of the present disclosure is shown. As seen in FIG. 3, the locations of the conductive cores and coils, and permanent magnets may vary. Further, there may be implementations which use conductive cores and coils without any permanent magnets.

In FIG. 3, a variation of FIG. 2 is shown. The electromagnetic propulsion engine 300 operates in the same manner as the electromagnetic propulsion engine 200, except that the locations of the permanent magnets 218a and 218b, the conductive cores 222a and 222b, and the coils 226a and 226b have changed.

In this implementation, the wiring from the control module 228 to the coils 226a and 226b may be secured to the connecting rod 206 and exits the crankcase 214. In various implementations, the wiring may be positioned in any way that it would not interfere with movement of the piston 204 and the connecting rod 206. Also, it is noted that the permanent magnet 216 may be replaced with a conductive core, coils, and wiring, wherein the wiring may be placed through a slit within the piston 204 so as to not interfere with movement of the piston 204 and the connecting rod 206. Further, the conductive core 220 and the coils 224 may be replaced by at least one permanent magnet.

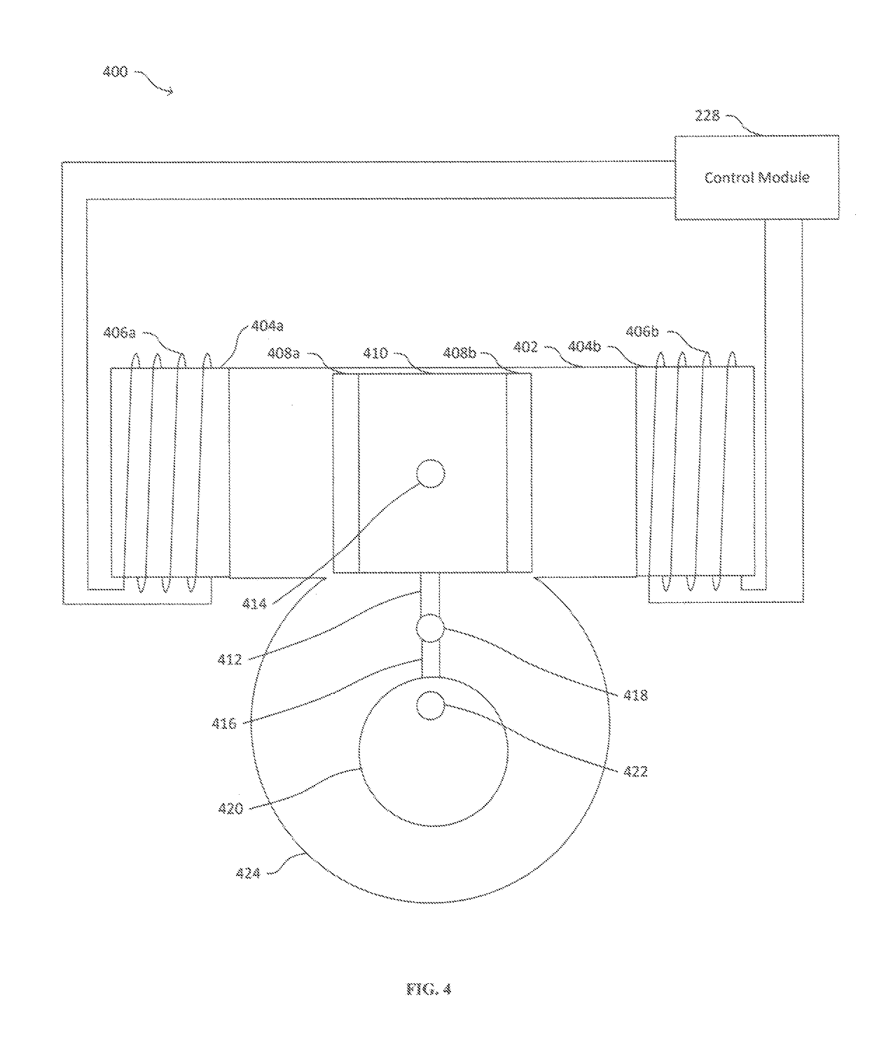

Referring now to FIG. 4, a structural schematic drawing of a cross section through a piston, cylinder, crankshaft, and magnetic bodies of a third exemplary electromagnetic propulsion engine according to the principles of the present disclosure is shown. An electromagnetic propulsion engine 400 includes a cylinder 402. The cylinder 402 is made of a nonferromagnetic material. A conductive core 404a is secured to one end of the cylinder 402. A conductive core 404b is secured to a second end of the cylinder 402. Coils 406a and 406b each may be made of one or more wires that wrap around conductive cores 404a and 404b respectively.

Permanent magnets 408a and 408b are secured to opposite ends of a piston 410. The piston 410 may be made of nonferromagnetic material. In various implementations, the piston 410 may be made of ferromagnetic material. One end of a connecting rod 412 is connected to the piston 410 via a pin 414. A second end of the connecting rod 412 is connected to one end of a connecting rod 416 via a pin 418. A second end of the connecting rod 416 is connected to a crankshaft 420 via a pin 422.

The control module 228 selectively transmits current through the coils 406a and 406b to force movement of the piston 410 within the cylinder 402 in the same manner as described above. As the piston 410 moves within the cylinder 402, the crankshaft 420 rotates within the crankcase 424. In various implementations, there may be more than one crankshaft 420 that is rotated based on the movement of the piston 410.

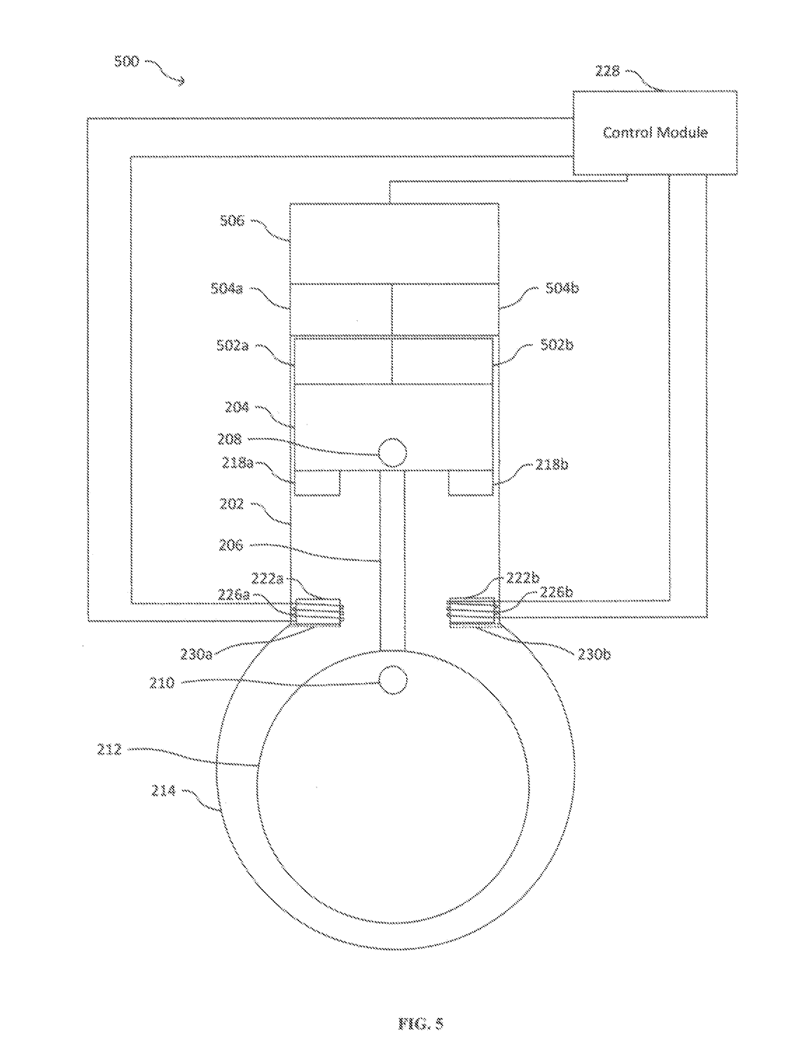

Referring now to FIG. 5, a structural schematic drawing of a cross section through a piston, cylinder, crankshaft, and magnetic bodies of a fourth exemplary electromagnetic propulsion engine according to the principles of the present disclosure is shown. The assembly of an electromagnetic propulsion engine 500 is similar to the electromagnetic propulsion engine 200.

In this exemplary implementation, permanent magnets 502a and 502b are secured to the piston 204. Permanent magnets 504a and 504b are secured to a rotating apparatus 506. The rotating apparatus 506 may be secured to the housing or to the cylinder 202. Permanent magnets 502a and 502b act on permanent magnets 504a and 504b respectively. For example only, permanent magnets 502a and 504a may have a negative polarity at the ends closest to each other, while permanent magnets 502b and 504b may have a positive polarity at the ends closest to each other.

The rotating apparatus 506 is an apparatus that is capable of rotating about an axis. For example only, the rotating apparatus 506 may rotate so that permanent magnet 504a is aligned with permanent magnet 502b and permanent magnet 504b and is aligned with 502a. The control module 228 may transmit one of a repel signal and an attract signal to the rotating apparatus. The rotating apparatus 506 rotates based on the signal received.

When the control module 228 transmits the repel signal, the rotating apparatus 506 rotates so that permanent magnets 504a and 502a are aligned with each other and permanent magnets 504b and 502b are aligned with each other. The repelling forces will cause the piston 204 to move away from the rotating apparatus 506. The control module 228 may transmit the repel signal when the piston 204 is at or near TDC. The control module 228 may continue transmitting the repel signal for a predetermined amount of time or until the piston 204 is at or near BDC.

When the control module 228 transmits the attract signal, the rotating apparatus 506 rotates so that permanent magnets 504a and 502b are aligned with each other and permanent magnets 504b and 502a are aligned with each other. The attracting forces will cause the piston 204 to move toward the rotating apparatus 506. The control module 228 may transmit the attract signal when the piston 204 is at or near BDC. The control module 228 may continue transmitting the attract signal for a predetermined amount of time or until the piston 204 is at or near TDC. The control module 228 may also transmit current to the coils 226a and 226b in the same manner as described above.

In another embodiment, the rotating apparatus 506 may rotate so that permanent magnets 504a and 504b are not acting on permanent magnets 502a and 502b respectively. For example only, the rotating apparatus may rotate about a horizontal axis so that the permanent magnets 504a and 504b are positioned away from the permanent magnets 502a and 502b, and therefore, may not act on permanent magnets 502a and 502b.

In each of the various implementations of the present disclosure, the control module 228 may adjust the strength of the electromagnetic fields by adjusting the amount of current being transmitted from the control module 228. Also, it is noted that the magnetic bodies may need to be replaced to maintain a predetermined force to operate effectively.

Although not shown, the exemplary electromagnetic propulsion engines of the present disclosure may include chains, gears, a pressure release valve, a lubrication system, a water system, and other traditional components. Again, only portions of the exemplary electromagnetic propulsion engines have been shown for simplicity reasons.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. An electromagnetic propulsion engine having at least one cylinder, at least one piston, a crankcase, at least one connecting rod secured to said piston and pivotally to a crankshaft enclosed within said crankcase, comprising:
a first magnetic body secured to a first end of said cylinder;
a second magnetic body secured to said cylinder;
a third magnetic body secured to a first end of said piston;
a fourth magnetic body secured to a second end of said piston;
wherein at least one of said first, second, third, and fourth magnetic bodies comprises an electromagnet; and
a control module that selectively transmits current to said electromagnet to force said piston to move within said cylinder between said first magnetic body and said second magnetic body, and thereby, rotating said crankshaft.

2. The electromagnetic propulsion engine of claim 1, wherein the strength of said electromagnet is adjustable.

3. The electromagnetic propulsion engine of claim 1, wherein said control module continuously transmits said current.

4. The electromagnetic propulsion engine of claim 1, wherein said control module suspends transmitting said current periodically.

5. The electromagnetic propulsion engine of claim 1, wherein said control module selectively adjusts said current.

6. The electromagnetic propulsion engine of claim 5, wherein said control module adjusts said current continuously.

7. The electromagnetic propulsion engine of claim 5, wherein said control module adjusts said current periodically.

8. The electromagnetic propulsion engine of claim 5, wherein said control module adjusts said current by reversing said current.

9. The electromagnetic propulsion engine of claim 8, wherein said control module reverses said current periodically.

10. An electromagnetic propulsion engine having at least one cylinder, at least one piston, a crankcase, at least one connecting rod secured to said piston and pivotally to a crankshaft enclosed within said crankcase, comprising:
a first magnetic body secured to a first end of said cylinder;
a second magnetic body secured to a second end of said cylinder;
wherein said piston comprises a third magnetic body;
wherein at least one of said first, second, and third magnetic bodies comprises an electromagnet; and
a control module that selectively transmits current to said electromagnet to force said piston to move within said cylinder between said first magnetic body and said second magnetic body, and thereby, rotating said crankshaft.

11. The electromagnetic propulsion engine of claim 10, wherein the strength of said electromagnet is adjustable.

12. The electromagnetic propulsion engine of claim 10, wherein said control module continuously transmits said current.

13. The electromagnetic propulsion engine of claim 10, wherein said control module suspends transmitting said current periodically.

14. The electromagnetic propulsion engine of claim 10, wherein said control module selectively adjusts said current.

15. The electromagnetic propulsion engine of claim 14, wherein said control module adjusts said current continuously.

16. The electromagnetic propulsion engine of claim 14, wherein said control module adjusts said current periodically.

17. The electromagnetic propulsion engine of claim 14, wherein said control module adjusts said current by reversing said current.

18. The electromagnetic propulsion engine of claim 17, wherein said control module reverses said current periodically.
